(19) United States
(12) Patent Application Publication
(10) Pub. No.: US 2005/0203274 A1
(43) Pub. Date: Sep. 15, 2005

(54) Dmc catalysts, polyether alcohols, and method for the production thereof

(75) Inventors: Edward Bohres, Mannheim (DE); Dirk Franke, Birkenheide (DE); Michael Stosser, Neuhofen (DE); Raimund Ruppel, Dresden (DE); Eva Baum, Schwarzheide (DE); Kathrin Harre, Dresden (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/514,714

(22) PCT Filed: Jun. 18, 2003
(86) PCT No.: PCT/EP03/06410

§ 371 Date: Nov. 23, 2004

(30) Foreign Application Priority Data
Jun. 24, 2002 (DE) 102 28 254.4

(51) Int. Cl. C08G 65/04

(52) U.S. Cl. 528/412

(57) ABSTRACT

The invention relates to a process for preparing polyether alcohols by addition of alkylene oxides onto H-functional starter substances using multimetal cyanide compounds as catalysts, wherein the multimetal cyanide compound is prepared by a process comprising the steps: a) adding a metal salt solution to a cyanometalate solution at a specific stirring power ε in the range from 0.05 to 10 W/l, preferably from 0.4 to 4 W/l, a temperature in the range from 0° C. to 100° C., preferably from 20° C. to 60° C., and an addition time of from 5 to 120 minutes, b) reducing the specific stirring power ε to a value in the range from 0.03 to 0.8 W/l and at the same time adding a surface-active agent, c) heating the solution while stirring at a specific stirring power ε of from 0.03 to 0.8 W/l, to a temperature of not more than 100° C., preferably in the range from 55° C. to 75° C., d) adding further metal salt solution while stirring at a specific stirring power ε of from 0.03 to 0.8 W/l, e) when the conductivity begins to drop, dispersing the solid, for example by stirring while increasing the specific stirring power ε to >0.7 W/l or by installation of a pumped circuit with an appropriate pump or by means of a high-speed stirrer, f) stirring at the specific stirring power ε of step e) until the conductivity or the pH remains constant, g) separating off the multimetal cyanide compound and washing it with water and, if desired, h) drying the catalyst.

The present invention relates to a process for preparing polyether alcohols by addition of alkylene oxides onto compounds having active hydrogen atoms using multimetal cyanide compounds as catalysts.

Polyether alcohols are important starting materials in the preparation of polyurethanes. They are usually prepared by catalytic addition of lower alkylene oxides, in particular ethylene oxide and/or propylene oxide, onto H-functional starter substances.

Catalysts used are usually soluble basic metal hydroxides or salts, with potassium hydroxide having the greatest industrial importance. A disadvantage of using potassium hydroxide as catalyst is, in particular, that formation of unsaturated by-products occurs in the preparation of high molecular weight polyether alcohols, and these reduce the functionality of the polyether alcohols and have very adverse effects in the preparation of polyurethanes.

To reduce the content of unsaturated components in the polyether alcohols and to increase the reaction rate in the addition reaction with propylene oxide, it has been proposed that multimetal cyanide compounds, preferably double metal cyanide compounds, frequently also referred to as DMC catalysts, be used as catalysts. There is a large number of publications in which such compounds have been described. They are customarily prepared by reacting solutions of metal salts, usually zinc chloride, with solutions of alkali metal or alkaline earth metal cyanometalates, e.g. potassium hexacyanocobaltate, or cyanometalic acids. Normally, a water-miscible component containing one or more heteroatoms is added to the resulting suspension immediately after the precipitation procedure. This component can also be initially present in one or both of the starting solutions. The water-miscible, heteroatom-containing component is preferably an ether, polyether, alcohol, ketone or a mixture of at least two of the compounds mentioned. Such processes have been described frequently, for example in U.S. Pat. No. 3,278,457, U.S. Pat. No. 3,278,458, U.S. Pat. No. 3,278,459, U.S. Pat. No. 3,427,256.

Although multimetal cyanide compounds have a very high catalytic activity and the addition reaction with the alkylene oxides proceeds at a very high reaction rate, they are usually not able to add alkylene oxides directly onto low molecular weight starter substances. For the purposes of the present invention, low molecular weight starter substances are, in particular, alcohols having a molecular weight in the range from −62 to 400 g/mol. Examples are glycerol, ethylene glycol, propylene glycol, trimethylolpropane, pentaerythritol, diethylene glycol and butanediol. When these compounds are used, there is usually a significant delay in commencement of the reaction, which is known as the induction period. In industrial plants, this can lead to hazardous situations.

One possible way of solving this problem is to increase the amount of the catalyst used significantly. However, this would have an adverse effect on the economics of the process.

In a further possible way of circumventing this problem, reaction products obtained by reacting low molecular weight alcohols with alkylene oxides and having a molecular weight in the range from 400 to 1000 g/mol are usually used as starter substances when multimetal cyanide compounds are employed. Such intermediates react with the alkylene oxides without an induction period. These intermediates are usually prepared with the aid of alkali metal hydroxides as catalysts. Since alkali metal hydroxides act as catalyst poisons in respect of multimetal cyanide compounds, the intermediates have to be laboriously purified.

A further possible way of circumventing this problem is continuous addition of the low molecular weight alcohols used as starter substances to the reaction mixture during the polymerization, as described, for example, in WO 98/03571 and WO 97/29146. However, this procedure restricts the opportunities of varying the composition of the chain of the polyether alcohols.

It is an object of the present invention to develop a process for preparing polyether alcohols by addition of alkylene oxides onto H-functional starter substances using multimetal cyanide compounds as catalysts, in which it is possible to add the alkylene oxides directly onto the H-functional starter substances, in particular alcohols having at least two hydroxyl groups, without there being a delay in commencement of the reaction. The process should be simple and not have additional process steps. The amount of catalyst used should be less than 1000 ppm, preferably less than 500 ppm, based on the polyether alcohol.

We have found that this object is achieved by using multimetal cyanide compounds which have been prepared by a specific sequence of process steps. We have found that the use of even small amounts of these multimetal cyanide compounds makes the addition of alkylene oxides onto low molecular-weight, preferably monomeric, H-functional starter substances possible without occurrence of a significant induction period.

The present invention accordingly provides a process for preparing polyether alcohols by addition of alkylene oxides onto H-functional starter substances using multimetal cyanide compounds as catalysts, wherein the multimetal cyanide compound is prepared by a process comprising the steps:
a) adding a metal salt solution to a cyanometalate solution at a specific stirring power ε in the range from 0.05 to 10 W/l, preferably from 0.4 to 4 W/l, a temperature in the range from 0° C. to 100° C., preferably from 20° C. to 60° C., and an addition time of from 5 to 120 minutes,
b) reducing the specific stirring power ε to a value in the range from 0.03 to 0.8 W/1 and at the same time adding a surface-active agent,
c) heating the solution while stirring at a specific stirring power ε of from 0.03 to 0.8 W/l, to a temperature of not more than 100° C., preferably in the range from 55° C. to 75° C.,
d) adding further metal salt solution while stirring at a specific stirring power ε of from 0.03 to 0.8 W/l,
e) when the conductivity begins to drop, dispersing the solid, for example by stirring while increasing the specific stirring power ε to >0.7 W/1 or by installation of a pumped circuit with an appropriate pump or by means of a high-speed stirrer
   f) stirring at the specific stirring power ε of step e) until the conductivity or the pH remains constant,
   g) separating off the multimetal cyanide compound and washing it with water and, if desired,
   h) drying the catalyst.

The intermediate obtained after step a) usually has a conductivity of about 0.7 mS/cm and a pH of about 3.0, that obtained after step d) usually has a conductivity of about 3.7 mS/cm and a pH of about 4.0 and that obtained after step f) has a conductivity of about 0.8 mS/cm and a pH of about 3.1.

It is possible for at least one of the steps a) to f) to be carried out in the presence of at least one organic ligand and/or an organic additive. These compounds are described in more detail below.

The parameter specific stirring power ε is known to those skilled in the art and can be defined as follows (M. Zogg; Einführung in die Mechanische Verfahrenstechnik, B. B. Teubner Stuttgart):
ε=Ne*ρ*n³*d⁵/V,
where Ne is the power index of the stirrer, ρ is the density of the medium being stirred, n is the rotation rate of the stirrer, d is the stirrer diameter, V is the volume of the liquid.

The surface-active agents added in step b) are usually added in an amount in the range from 15 to 50% by weight, preferably in an amount of about 30% by weight, in each case based on the theoretical weight of the DMC catalyst. They serve, in particular, to adjust the morphology of the DMC catalyst and are usually removed from the catalyst using washing, except for small residual amounts which may remain in the catalyst. In principle, it is also possible to use larger amounts of surface-active compounds. However, this would make catalyst production more expensive without leading to significant improvements in the properties of the DMC catalyst.

For the purposes of the present invention, surface-active agents are compounds which reduce the surface tension of water. Surface-active agents have a characteristic structure and have at least one hydrophilic functional group and one hydrophobic functional group. The hydrophilic parts of the molecule are usually polar functional groups (—COO—, —OSO₃—, —SO₃₋), while the hydrophobic parts are generally nonpolar hydrocarbon radicals.

In particular, nonionic and/or polymeric surfactants are used. Particularly useful examples of compounds of this group are fatty alcohol alkoxylates, block copolymers of various epoxides having different hydrophilicities, castor oil alkoxylates or block copolymers of epoxides and other monomers such as acrylic acid or methacrylic acid. The substances used should have a moderate to good solubility in water.

The fatty alcohol alkoxylates employed as surface-active agents in the preparation of the DMC catalysts used according to the present invention can be prepared by reacting a fatty alcohol, preferably one having 8-36 carbon atoms, in particular 10-18 carbon atoms, with ethylene oxide, propylene oxide and/or butylene oxide. The polyether part of the fatty alcohol alkoxylate used according to the present invention can be made up of pure ethylene oxide, propylene oxide or butylene oxide polyether. Furthermore, copolymers of two or three different alkylene oxides or block copolymers of two or three different alkylene oxides are also possible. Fatty alcohol alkoxylates which have pure polyether chains are, for example, Lutensol® AO grades from BASF AG. Examples of fatty alcohol alkoxylates having block copolymers as polyether part are Plurafac® LF grades from BASF AG. The polyether chains are particularly preferably composed of from 2 to 50, in particular 3-15, alkylene oxide units.

Block copolymers as surfactants comprise two different polyether blocks which have differing hydrophilicities. Block copolymers which can be used according to the present invention can comprise ethylene oxide and propylene oxide (Pluronic® grades, BASF AG). The water solubility of these is controlled via the lengths of the various blocks. The molar masses are in the range from 500 Da to 20 000 Da, preferably from 1000 Da to 6000 Da, in particular from 1500 to 4000 Da. In the case of the ethylene oxide/propylene oxide copolymers, the proportion of ethylene oxide is from 5 to 50% by weight and the proportion of propylene oxide is from 50 to 95% by weight.

Copolymers of alkylene oxide with other monomers to be used for the purposes of the present invention preferably have ethylene oxide blocks. Examples of other monomers which can be used are butyl methacrylate (PBMA/PEO BE1010/BE1030, Th. Goldschmidt), methyl methacrylate (PMMA/PEO ME1010/ME1030, Th. Goldschmidt) or methacrylic acid (EA-3007, Th. Goldschmidt).

The double metal cyanide catalysts used according to the present invention have the formula (I)
M¹ₐ[M²(CN)_{b}(A)_{c}]_{d}.fM¹_{g}Xₙ.h(H₂O)eL.kP (I)
where
M¹ is a metal ion selected from the group consisting of Zn²⁺, Fe²⁺, Fe³⁺, Co³⁺, Ni²⁺, Mn²⁺, Co²⁺, Sn²⁺, Sn⁴⁺, Pb²⁺, Mo⁴⁺, Mo⁶⁺, Al³⁺, V⁴⁺, V⁵⁺ ₁ Sr²⁺, W⁴⁺, W⁶⁺, Cr²⁺, Cr³⁺, Cd²⁺, Cu²⁺, La³⁺, Ce³⁺, Ce⁴⁺, Eu³⁺, Mg²⁺, Ti³⁺, Ti⁴⁺, Ag⁺, Rh²⁺, Ru²⁺, Ru³⁺,
M² is a metal ion selected from the group consisting of Fe²⁺, Fe³⁺, Co²⁺, Co³⁺, Mn²⁺, Mn³⁺, Ni²⁺ V⁴⁺, V⁵⁺, Cr²⁺, Cr³⁺, Rh³⁺, Ru²⁺, Ir³⁺,
   where M¹ and M² are different,
A is selected from the group consisting of the anions halide, hydroxide, sulfate, hydrogensulfate, carbonate, hydrogencarbonate, cyanide, thiocyanate, isocyanate, cyanate, carboxylate, oxalate, nitrate, nitrosyl, phosphate, hydrogenphosphate and dihydrogenphosphate and the uncharged species CO, H₂O and NO,
X is an anion selected from the group consisting of halide, hydroxide, sulfate, hydrogensulfate, carbonate, hydrogencarbonate, cyanide, thiocyanate, isocyanate, cyanate, carboxylate, oxalate, nitrate and nitrite (NO₂—),
L is a water-miscible ligand selected from the group consisting of alcohols, aldehydes, ketones, ethers, polyethers, esters, polyesters, polycarbonate, ureas, amides, nitriles, sulfides, amines, phosphides, phosphites, phosphines, phosphonates, phosphates and mixtures thereof,
P is an organic additive which is different from and is selected from the group consisting of polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylamide-co-maleic acid), polyacrylonitrile, polyalkyl acrylates, polyalkyl methacrylates, polyvinyl methyl ethers, polyvinyl ethyl ethers, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkylenimines, maleic acid and maleic anhydride copolymers, hydroxyethylcellulose, polyacetates, ionic surface-active compounds, bile acids and their salts, esters, amides, carboxylic esters of polyhydric alcohols and glycosides, and
a, b, d, g and n are integers or fractions greater than zero,
c, f, e, h and k are integers or fractions greater than or equal to zero,
   where
a, b, c, and d, and also g and n are selected so that the compound is electrically neutral,
and f and k can be zero only when c is not zero and A is exclusively carboxylate, oxalate or nitrate.

The carboxylate is particularly preferably acetate.

These catalysts can be crystalline or amorphous. When k is zero, crystalline double metal cyanide compounds are preferred. When k is greater than zero, crystalline, partially crystalline and substantially amorphous catalysts are all preferred.

The organic additive can be the surface-active compound.

There are various preferred embodiments of the catalysts of the present invention.

In one preferred embodiment, k in catalysts of the formula (I) is greater than zero.

The preferred catalyst then comprises:
a) at least one multimetal cyanide compound,
b) at least one organic ligand,
c) at least one organic additive P.

In another preferred embodiment, k is zero, e may also be zero and X is exclusively carboxylate, preferably formate, acetate or propionate. In this embodiment, the multimetal cyanide compounds are preferably crystalline.

Particularly useful ligands are described in WO 01/03830. Such catalysts are prepared using organic sulfones of the formula R—S(O)₂—R or sulfoxides of the formula R—S(O)—R as organic complexing agent. DMC catalysts which have been prepared in this way have particularly short induction times and lead to a moderately exothermic polymerization of the alkylene oxides.

In a particularly advantageous embodiment of the process of the present invention, nitriles, in particular acetonitrile, are/is used as ligand(s). Such catalysts are particularly active and have very short induction periods. They can advantageously be used for the addition of alkylene oxides onto low molecular weight starters, for example glycols, glycerol or trimethylolpropane.

The amount of the heteroatom-containing ligands present in the suspension formed after the precipitation should be from 1 to 60% by weight, preferably from 5 to 40% by weight, in particular from 10 to 30% by weight.

In a particularly preferred embodiment of the invention, the multimetal cyanide compounds are crystalline and platelet-shaped. Such catalysts are described, for example, in WO 00/74843.

The catalysts of the present invention are prepared, as described above, by combining a metal salt solution with a cyanometalate solution, which may optionally further comprise both an organic ligand L and an organic additive P, in the sequence of process steps prescribed according to the present invention. It is also possible to add the organic ligand and the organic additive after each time the metal salt solution is combined with the cyanometalate solution in one of the process steps prescribed according to the present invention.

After the multimetal cyanide compound has been separated off in step g), it can be washed. This is usually carried out using water. It is possible to add further ligands and/or additive to this water.

The multimetal cyanide compound obtained in this way can be dried and used in this form as catalyst for the polymerization of alkylene oxides.

The catalyst prepared as described above can be isolated by filtration or centrifugation and be dried, preferably at from 30 to 200° C., preferably at a pressure of from 100 to 10-³ mbar, particularly preferably at 50° C. and 15 mbar.

The dried catalyst is then milled, as described, for example, in U.S. Pat. No. 3,829,505 and U.S. Pat. No. 5,714,639. However, the catalyst can also be dried by spray drying or freeze drying, as described, for example, in U.S. Pat. No. 5,900,384.

Alternatively, the moist filter cake obtained after the multimetal cyanide compounds have been separated off and washed can also be used as catalyst for the polymerization of alkylene oxides.

In a preferred embodiment of the invention, the multimetal cyanide compounds are used as catalyst in the form of a suspension.

In this embodiment, the catalyst is suspended in organic or inorganic liquids, preferably in the starter compound used for preparing the polyether alcohols. This suspension procedure is carried out in suitable apparatuses such as Ultraturrax, homogenizers or stirred mills with introduction of very high shear energy. Such a procedure is described, for example, in WO 00/74843.

The DMC catalysts of the present invention can also be applied to supports, as described, for example, in WO 01/04180 for polycarboxylic acids and in WO 01/04177 for zeolites. This allows the catalyst to be separated from the polyether alcohol in a simple fashion.

Metal salts used for the preparation of the multimetal cyanide compounds of the present invention are usually salts of the formula (II)
M¹_{g}Xₙ (II)
where M¹ and X are as defined above and g and n are chosen so that the compound is electrically neutral.

The metal salts used in the steps a) and d) can be identical or different.

The cyanometalate compounds used for the preparation of the multimetal cyanide compounds of the present invention are usually compounds of the formula (III)
Meₚ[M²(CN)_{b}]_{d} (III)
where M², b and d are as defined above, Me is an alkali-metal, an alkaline earth metal or hydrogen, p is an integer or fraction greater than zero and p, b and d are selected so that the compound is electrically neutral.

In a preferred embodiment of the invention, Me is hydrogen, i.e. a cyanometalic acid is used. The multimetal cyanide compounds prepared in this way display a particularly good catalytic activity. In addition, their work-up is simplified since there is no inevitable formation of troublesome salts.

In another preferred embodiment of the catalysts, f, e and k are nonzero. These multimetal cyanide compounds comprise a water-miscible organic ligand, preferably in an amount of from 0.5 to 30% by weight, based on the multimetal cyanide compound of the formula (I), and an organic additive, preferably in an amount of from 5 to 80% by weight, based on the multimetal cyanide compound of the formula (I).

As stated, the multimetal cyanide compounds prepared by the process of the present invention can be used as catalysts for the polymerization of alkylene oxides.

The polyether alcohols are prepared by addition of alkylene oxides onto H-functional starter substances in the presence of the catalysts obtained according to the present invention.

Alkylene oxides which can be used are all known alkylene oxides, for example ethylene oxide, propylene oxide, butylene oxide and/or styrene oxide. Particular preference is given to using ethylene oxide, propylene oxide and mixtures of these as alkylene oxides.

Starter substances used are H-functional compounds. Particular preference is given to using alcohols having a functionality of from 1 to 8, preferably of from 2 to 8. Starter substances used for preparing polyether alcohols which are to be employed for flexible polyurethane foams are, in particular, alcohols having a functionality of from 2 to 4, in particular 2 and 3. Examples are ethylene glycol, propylene glycol, glycerol, trimethylolpropane and pentaerythritol. In the addition reaction of the alkylene oxides in the presence of DMC catalysts, it is advantageous to use the reaction products of the alcohols mentioned with alkylene oxides, in particular propylene oxide, together with or in place of the alcohols themselves. Such reaction products preferably have a molar mass of up to 500 g/mol. The addition reaction of the alkylene oxides in the preparation of these reaction products can be catalyzed by any catalysts, for example basic catalysts. The polyether alcohols for producing flexible polyurethane foams usually have a hydroxyl number in the range from 20 to 100 mg KOH/g.

The addition reaction of the alkylene oxides in the preparation of the polyether alcohols used for the process of the present invention can be carried out by known methods. Thus, it is possible for the polyether alcohols to contain only one alkylene oxide. When using a plurality of alkylene oxides, it is possible for these to be added on in blocks, i.e. the alkylene oxides are added on individually in succession, or they can be added on randomly, in which case the alkylene oxides are introduced together. It is also possible for both blockwise sections and random sections to be incorporated in the polyether chain in the preparation of the polyether alcohols.

To produce flexible polyurethane slabstock foams, preference is given to using polyether alcohols having a high content of secondary hydroxyl groups and a content of ethylene oxide units in the polyether chain of not more than 30% by weight, based on the weight of the polyether alcohol. These polyether alcohols preferably have a propylene oxide block at the end of the chain.

To produce molded flexible polyurethane foams, particular preference is given to using polyether alcohols having a high content of primary hydroxyl groups and an ethylene oxide end block in an amount of <20% by weight, based on the weight of the polyether alcohol.

The addition reaction of the alkylene oxides is carried out under conditions customary for this purpose, for example temperatures in the range from 60 to 180° C., preferably from 90 to-140° C., in particular from 100 to 130° C., and pressures in the range from 0 to 20 bar preferably in the range from 0 to 10 bar and in particular in the range from 0 to 5 bar. The mixture of starter substance and DMC catalyst can be pretreated by stripping as described in WO 98/52689 before commencement of the alkoxylation.

After the addition reaction of the alkylene oxides is complete, the polyether alcohol is worked up by customary methods, with unreacted alkylene oxides and volatile constituents being removed, usually by distillation, steam stripping or gas stripping and/or other deodorization methods. If necessary, the polyether alcohol can also be filtered.

After conclusion of the addition reaction of the alkylene oxides, the catalyst can be separated off from the reaction mixture. However, for most applications of the polyether alcohols, in particular in the preparation of polyurethanes, it is possible for it to be left in the product.

Customary stabilizers, in particular those which inhibit thermooxidative degradation, can be added to the finished polyether alcohol in the amounts customary for this purpose.

The catalyst of the present invention can be used in an amount of less than 1000 ppm, preferably less than 500 ppm, in particular less than 200 ppm. However, the catalyst content should not go below 10 ppm, since otherwise it usually has insufficient catalytic effect.

The use of the multimetal cyanide compounds prepared by the process of the present invention allows polyetherols having improved properties to be prepared from low molecular weight starter substances, in particular ethylene glycol, propylene glycol, glycerol, trimethylolpropane, pentaerythritol and mixtures thereof, in the presence of a low catalyst concentration. No induction period occurs at the beginning of the polymerization even at very low catalyst concentrations.

The polyether alcohols prepared using the DMC catalysts of the present invention are preferably employed for producing polyurethanes, in particular polyurethane foams and especially flexible polyurethane foams. The polyurethanes are produced by reacting the polyether alcohols with polyisocyanates in the presence of catalysts, blowing agents and, if desired, other customary auxiliaries and/or additives.

### EXAMPLES

### Example 1

353.9 kg of aqueous hexacyanocobaltic acid (cobalt content: 9 g/l, calculated as cobalt) were placed in a stirred vessel having a volume of 800 l, and equipped with an inclined-blade turbine, immerese tube for introduction of reactants, pH electrode, conductivity measurement cell and scattered light probe and were heated to 50° C. while stirring. 215.7 kg of aqueous zinc acetate dihydrate solution (zinc content: 2.5% by weight), which had likewise been heated to 50° C., were subsequently fed in over a period of 45 minutes while stirring at a stirring power of 1 W/l.

After the addition was complete, a stirring power of 0.4 W/l was set and a solution of 7.67 kg of Pluronic® PE 6200 (BASF AG) in 10 kg of water was added. The mixture was heated to 60° C. and stirred at this temperature for another two hours. 70.5 kg of aqueous zinc acetate dihydrate solution (zinc content: 2.5% by weight) were subsequently metered in at 60° C. over a period of 20 minutes while stirring at a stirring power of 0.4 W/l. After a few minutes, the conductivity began to drop. The mixture was then stirred further at a stirring power of 1.5 W/l.

The suspension was stirred at 60° C. and a stirring power of 1.5 W/1 until the pH had dropped from 4.15 to 3.09 and remained constant. The suspension obtained in this way was subsequently filtered by means of a filter press and the precipitate was washed with 400 l of water in the filter press.

The moist filter cake was dried at 50° C. under reduced pressure.

### Example 2

Preparation of Polyether Alcohols

134 g (1 mol) of the starter dipropylene glycol together with 0.18 g of the DMC catalyst from example 1 (200 ppm based on the amount of the polyether alcohol) were placed in a 2 l stirring autoclave. The mixture was subsequently dewatered for two hours at 100° C. and 0-10 mbar, nitrogen was then admitted to bring the pressure to atmospheric pressure and the mixture was stirred overnight at 100° C. It was subsequently heated to 135° C. and the alkoxylation was commenced. For this purpose, the pressure was increased to 4 bar over a period of 30 minutes by addition of 50 ml of propylene oxide which was under an initial nitrogen pressure.

The internal pressure in the reactor was then increased to 8 bar over a period of a further 30 minutes while introducing 250 g of propylene oxide.

At 9 bar and a reaction temperature of 135° C., a significant pressure decrease from 9 bar to 1 bar was observed after a time of about 4-5 hours. The remaining propylene oxide was then introduced at from 1 to 3 bar and a temperature of 135° C., so that the total amount of propylene oxide was 756 g (13.03 mol). After the reaction was complete, the reaction mixture was stripped with nitrogen, unreacted propylene oxide was taken off at 100° C. under reduced pressure (10 mbar) and the mixture was filtered through a deep bed filter.

This gave 886.8 g of a colorless liquid, corresponding to 13 mol of propylene oxide/mol of starter.

Properties of the Polymer Obtained:

| | |
|---|---|
| Polydispersity: | 1.053, determined by means of GPC |
| Co (residual content): | 1 ppm |
| Zn (residual content): | 3 ppm |
| Hydroxyl number: | 119 mg KOH/g |
| Kaufmann iodine number: | <1 g of iodine/100 g |

### Comparative Example 1

Preparation of the Catalyst

370 kg of aqueous hexacyanocobaltic acid (cobalt content: 9 g/l, calculated as cobalt) were placed in a stirred vessel having a volume of 800 l, and equipped with an inclined-blade turbine, immerese tube for introduction of reactants, pH electrode, conductivity measurement cell and scattered light probe and were heated to 50° C. while stirring. 209.5 kg of aqueous zinc acetate dihydrate solution (zinc content: 2.7% by weight), which had likewise been heated to 50° C., were subsequently fed in over a period of 50 minutes while stirring at a stirring power of 1 W/l.

8 kg of the surface-active agent Pluronic® PE 6200 (BASF AG) and 10.7 kg of water were subsequently added while stirring. 67.5 kg of aqueous zinc acetate dihydrate solution (zinc content: 2.7% by weight) were then introduced at 55° C. over a period of 20 minutes while stirring at a stirring power of 1 W/l.

The resulting suspension was stirred at 55° C. until the pH had dropped from 3.7 to 2.7 and remained constant. The suspension obtained in this was subsequently filtered by means of a filter press and the precipitate was washed with 400 l of water in the filter press.

### Comparative Example 2

### Preparation of the Polyether Alcohol

134 g (1 mol) of dipropylene glycol were admixed with 0.18 g (200 ppm) of the catalyst from comparative example 1.30 g of molecular sieves (4 A) were added thereto. The starter mixture prepared in this way was dewatered for 3 hours at 100° C. under a pressure of about 1 mbar. The vacuum was broken by means of nitrogen, the molecular sieves were filtered off and the starter mixture was introduced into a 2 l stirred reactor.

A pressure test was then carried out and the reactor was filled with nitrogen three times to make it inert. The mixture was subsequently heated to 130° C. After this temperature had been reached and the pressure had been ramped from 0.2 bar to 4 bar at a prescribed rate in order to observe commencement of the reaction, 50 g of propylene oxide were fed into the reactor.

After 11 minutes, the pressure in the reactor dropped to 3.9 bar, and after 120 minutes it had dropped to 1.8 bar. No exothermic reaction was observed. After a further pressure ramp (1.8 to 5 bar), 102 g of propylene oxide were fed into the reactor. The internal temperature in the reactor displayed a sharp initial increase, but decreased significantly after a few minutes. After 120 minutes, the pressure had dropped to 4.4 bar and subsequently remained constant at this value. Neither an exothermic reaction nor a further uptake of PO were observed. The experiment was stopped.

### Comparative Example 3

134 g (1 mol) of dipropylene glycol and 2.22 g of the DMC catalyst from comparative example 1 (corresponding to 2500 ppm based on the polyether alcohol) were placed in a 2 l stirring autoclave. The mixture was heated to 100° C. and dewatered for 2 hours at this temperature under reduced pressure (<20 mbar). The vacuum was then broken by means of nitrogen and the mixture was heated to 130° C. At an initial pressure of 0.3 bar, 20 g of propylene oxide were introduced, resulting in a pressure increase to 2 bar; after the pressure had dropped to 1.3 bar, a further 50 g of PO were introduced. After 4 hours and an internal pressure in the reactor of 3.2 bar, an exothermic reaction was observed. After a further 5 hours, the metered addition was complete (calculated amount of propylene oxide) and an exothermic reaction could no longer be observed. The mixture was stirred at 130° C. and a pressure of 5 bar for 9 hours to allow after-reaction to occur. The polypropylene glycol obtained weighed 902.3 g (corresponding to 13.2 mol of PO/mol of starter) and had a pink color. However, deep bed filtration gave a clear, colorless product.

1. A process for preparing double metal cyanide catalysts, comprising the steps:
a) adding a metal salt solution of the formula M¹_{g}Xn,
where
M¹ is a metal ion selected from the group comprising Zn²⁺, Fe²⁺, Fe³⁺, Co³⁺, Ni²⁺, Mn²⁺, Co²⁺, Sn²⁺, Sn⁴⁺, Pb²⁺, Mo⁴⁺, Mo⁶⁺, Al³⁺, V⁴⁺, V⁵⁺, Sr²⁺, W⁴⁺, W⁶⁺, Cr²⁺, Cr³⁺, Cd²⁺, Cu²⁺, La³⁺, Ce³⁺, Ce⁴⁺, Eu³⁺, Mg²⁺, Ti³⁺, Ti⁴⁺, Ag⁺, Rh²+, Ru²⁺, Ru³⁺, and g and n are selected so that the compound is electrically neutral, to a cyanometalate solution at a specific stirring power ε in the range from 0.05 to 10 W/l, preferably from 0.4 to 4 W/l, a temperature in the range from 0° C. to 100° C., preferably from 20° C. to 60° C., and an addition time of from 5 to 120 minutes,
b) reducing the specific stirring power ε to a value in the range from 0.03 to 0.8 W/1 and at the same time adding a surface-active agent,
c) heating the solution while stirring at a specific stirring power ε of from 0.03 to 0.8 W/l, to a temperature of not more than 100° C., preferably in the range from 55° C. to 75° C.,
d) adding further metal salt solution while stirring at a specific stirring power ε of from 0.03 to 0.8 W/l,
e) when the conductivity begins to drop, dispersing the solid, for example by stirring while increasing the specific stirring power ε to >0.7 W/l or by installation of a pumped circuit with an appropriate pump or by means of a high-speed stirrer,
f) stirring at the specific stirring power of step e) until the conductivity or the pH remains constant,
g) separating off the multimetal cyanide compound and washing it with water and, if desired,
h) drying the catalyst.

2. A double metal cyanide catalyst of the formula (I)
M¹ₐ[M²(CN)_{b}(A)_{c}]_{d}.fM¹_{g}Xₙ.h(H₂O)eL.kP (I)
where
M¹ is a metal ion selected from the group consisting of Zn²⁺, Fe²⁺, Fe³⁺, Co³⁺, Ni²⁺, Mn²⁺, Co²⁺, Sn²⁺, Sn⁴⁺, Pb²⁺, Mo⁴⁺, Mo⁶⁺, Al³⁺, V⁴⁺, V⁵⁺, Sr²⁺, W⁴⁺, W⁶⁺, Cr²⁺, Cr³⁺, Cd²⁺ ₁ Cu²⁺, La³⁺, Ce³⁺, Ce⁴⁺, Eu³⁺, Mg²⁺, Ti³⁺, Ti⁴⁺, Ag⁺, Rh²⁺, Ru²⁺, Ru³⁺,
M² is a metal ion selected from the group consisting of Fe²⁺, Fe³⁺, Co²⁺, Co³⁺, Mn²⁺, Mn³⁺, Ni²⁺ V⁴⁺, V⁵⁺, Cr²⁺, Cr³⁺, Rh³⁺, Ru²⁺, Ir³⁺,
where M¹ and M² are different,
A is selected from the group consisting of the anions halide, hydroxide, sulfate, hydrogensulfate, carbonate, hydrogencarbonate, cyanide, thiocyanate, isocyanate, cyanate, carboxylate, oxalate, nitrate, nitrosyl, phosphate, hydrogenphosphate and dihydrogenphosphate and the uncharged species CO, H₂O and NO,
X is an anion selected from the group consisting of halide, hydroxide, sulfate, hydrogensulfate, carbonate, hydrogencarbonate, cyanide, thiocyanate, isocyanate, cyanate, carboxylate, oxalate, nitrate and nitrite (NO₂—),
L is a water-miscible ligand selected from the group consisting of alcohols, aldehydes, ketones, ethers, polyethers, esters, polyesters, polycarbonate, ureas, amides, nitriles, sulfides, amines, phosphides, phosphites, phosphines, phosphonates, phosphates and mixtures thereof,
P is an organic additive selected from the group consisting of polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylamide-co-maleic acid), polyacrylonitrile, polyalkyl acrylates, polyalkyl methacrylates, polyvinyl methyl ethers, polyvinyl ethyl ethers, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkylenimines, maleic acid and maleic anhydride copolymers, hydroxyethylcellulose, polyacetates, ionic surface-active compounds, bile acids and their salts, esters, amides, carboxylic esters of polyhydric alcohols and glycosides, and
a, b, d, g and n are integers or fractions greater than zero, c, f, e, h and k are integers or fractions greater than or equal to zero,
where
a, b, c, and d, and also g and n are selected so that the compound is electrically neutral,
and f and k can be zero only when c is not zero and A is exclusively carboxylate, oxalate or nitrate,
prepared by a process comprising the steps:
a) adding a metal salt solution to a cyanometalate solution at a specific stirring power ε in the range from 0.05 to 10 W/l, preferably from 0.4 to 4 W/l, a temperature in the range from 0° C. to 100° C., preferably from 20° C. to 60° C., and an addition time of from 5 to 120 minutes,
b) reducing the specific stirring power ε to a value in the range from 0.03 to 0.8 W/1 and at the same time adding a surface-active agent,
c) heating the solution while stirring at a specific stirring power of from 0.03 to 0.8 W/l, to a temperature of not more than 100° C., preferably in the range from 55° C. to 75° C.,
d) adding further metal salt solution while stirring at a specific stirring power ε of from 0.03 to 0.8 W/l,
e) when the conductivity begins to drop, dispersing the solid, for example by stirring while increasing the specific stirring power ε to >0.7 W/1 or by installation of a pumped circuit with an appropriate pump or by means of a high-speed stirrer,
f) stirring at the specific stirring power ε of step e) until the conductivity or the pH remains constant,
g) separating off the multimetal cyanide compound and washing it with water and, if desired,
h) drying the catalyst.

3. A process for preparing double metal cyanide catalysts, which comprises the steps:
a) adding a metal salt solution to a cyanometalate solution at a specific stirring power ε in the range from 0.05 to 10 W/l, preferably from 0.4 to 4 W/l, a temperature in the range from 0° C. to 100° C., preferably from 20° C. to 60° C., and an addition time of from 5 to 120 minutes,
b) reducing the specific stirring power ε to a value in the range from 0.03 to 0.8 W/l and at the same time adding a surface-active agent,
c) heating the solution while stirring at a specific stirring power ε of from 0.03 to 0.8 W/l, to a temperature of not more than 100° C., preferably in the range from 55° C. to 75° C.,
d) adding further metal salt solution while stirring at a specific stirring power Eof from 0.03 to 0.8 W/l,
e) when the conductivity begins to drop, dispersing the solid, for example by stirring while increasing the specific stirring power ε to >0.7 W/l or by installation of a pumped circuit with an appropriate pump or by means of a high-speed stirrer,
f) stirring at the specific stirring power ε of step e) until the conductivity or the pH remains constant,
g) separating off the multimetal cyanide compound and washing it with water and, if desired,
h) drying the catalyst.

4. A polyether alcohol which can be prepared by a process as claimed in claim 1.

5. A process for preparing polyurethanes by reacting polyisocyanates with polyether alcohols as claimed in claim 4.
